(19) United States
(12) Patent Application Publication
(10) Pub. No.: US 2008/0126013 A1
(43) Pub. Date: May 29, 2008

(54) Modification of a user specific configuration of a remote on-line service application in accordance with accumulated physical activity data of the user

(75) Inventors: Sonja Kangas, Helsinki (FI); Pirjo Nakki, Espoo (FI); Arto Laikari, Helsinki (FI); Juha Koivisto, Espoo (FI)

Correspondence Address: HARRINGTON & SMITH, PC, 4 RESEARCH DRIVE, SHELTON, CT, 06484-6212, US

(73) Assignee: Valtion Teknillinen Tutkimuskeskus

(21) Appl. No.: 11/595,073

(22) Filed: Nov. 8, 2006

(51) Int. Cl. G06F 15/00

(52) U.S. Cl. 702/188

(57) ABSTRACT

The invention allows modifying a user's configuration of a remote on-line service application in accordance with accumulated physical activity data of the user. User's physical activity sensor data is accumulated in a mobile device from a physical activity sensor. In response to a predetermined event, physical activity information based on the accumulated physical activity sensor data is transferred from the mobile device to a networked computing device. The user's configuration of a remote on-line service application is then modified based on the transferred physical activity information.

### BACKGROUND OF THE INVENTION

1. Field of the Invention

The invention generally relates to collecting information of a user's physical activity. In particular, the invention relates to methods, computer programs and devices for collecting information of a user's physical activity and modifying a user specific on-line service application configuration in response.

2. Description of the Related Art

Today, various exercise and fitness activities are popular. They allow people to lose weight and to maintain general well-being.

Various sensor devices have been researched and developed to assist one in monitoring and keeping track of one's exercise and fitness activities. These sensor devices include e.g. pedometers, cyclometers and pulse meters.

Typically, these sensor devices only provide immediate feedback. That is, they display their respective data during an on-going exercise or fitness session and the data typically relates only to the on-going session. Also, the data is typically displayed as is without further analyzing it. Often, these sensor devices are also bulky and/or perceived as too technically oriented for casual use.

In other words, prior art exercise and fitness activity monitoring and tracking arrangements are aimed first and foremost at professional and semiprofessional users, such as athletes and the like.

Therefore, an object of the present invention is to alleviate the problems described above and to introduce an arrangement that allows exercise and fitness activity monitoring and tracking for a more casual user.

### SUMMARY OF THE INVENTION

A first aspect of the present invention is a method in which physical activity sensor data of a user is accumulated, over a period of time, in a mobile device from a physical activity sensor. In response to a predetermined event, physical activity information is transferred from the mobile device to a networked computing device, wherein the physical activity information is based on the accumulated physical activity sensor data. Based on the transferred physical activity information, the user's configuration of a remote on-line service application is modified with the networked computing device.

A second aspect of the present invention is a computer program embodied on a computer readable medium, the computer program controlling a data-processing device to perform the steps of:

accumulating, over a period of time, physical activity sensor data of a user in a mobile device from a physical activity sensor;

transferring, in response to a predetermined event, physical activity information from the mobile device to a networked computing device, the physical activity information based on the accumulated physical activity sensor data; and

modifying, with the networked computing device, the user's configuration of a remote on-line service application based on the transferred physical activity information.

A third aspect of the present invention is a mobile device which comprises a collector configured to accumulate, over a period of time, physical activity sensor data of a user from a physical activity sensor. The mobile device of the third aspect further comprises a dispatcher configured to dispatch, in response to a predetermined event, physical activity information based on the accumulated physical activity sensor data to a networked computing device for use in modifying, with the networked computing device, the user's configuration of a remote on-line service application based on the dispatched physical activity information.

A fourth aspect of the present invention is a networked computing device which comprises a receiver configured to receive, from a mobile device, physical activity information based on physical activity sensor data of a user accumulated in the mobile device over a period of time from a physical activity sensor. The networked computing device of the fourth aspect further comprises a modifier configured to modify the user's configuration of a remote on-line service application based on the received physical activity information.

A fifth aspect of the present invention is a mobile device which comprises a collecting means for accumulating, over a period of time, physical activity sensor data of a user from a physical activity sensor. The mobile device of the fifth aspect further comprises a dispatching means for dispatching, in response to a predetermined event, physical activity information based on the accumulated physical activity sensor data to a networked computing device for use in modifying, with the networked computing device, the user's configuration of a remote on-line service application based on the dispatched physical activity information.

A sixth aspect of the present invention is a networked computing device which comprises a receiving means for receiving, from a mobile device, physical activity information based on physical activity sensor data of a user accumulated in the mobile device over a period of time from a physical activity sensor. The networked computing device of the sixth aspect further comprises a modifying means for modifying the user's configuration of a remote on-line service application based on the received physical activity information.

In an embodiment of the invention, the accumulated physical activity sensor data is analyzed with the mobile device. In this embodiment, the physical activity information to be transferred comprises results of the performed analysis.

In an embodiment of the invention, the physical activity information to be transferred comprises the accumulated physical activity sensor data.

In an embodiment of the invention, the modifying of the user's configuration of the remote on-line service application comprises one of allowing or denying the user's access to at least a portion of the remote on-line service application in accordance with the transferred physical activity information.

In an embodiment of the invention, the modifying of the user's configuration of the remote on-line service application comprises modifying a predetermined feature of the remote on-line service application in accordance with the transferred physical activity information.

In an embodiment of the invention, the predetermined event comprises a predetermined command input by the user.

In an embodiment of the invention, the physical activity information is transferred to a predetermined networked computing device.

In an embodiment of the invention, a networked computing device located within a short range of the mobile device is discovered with the mobile device. In this embodiment, the physical activity information is transferred to the discovered networked computing device.

In an embodiment of the invention, the accumulating of the physical activity sensor data, the transferring of the physical activity information, and the modifying of the user's configuration of the remote on-line service application are periodically repeated. In this embodiment, with each repeat physical activity information based on physical activity sensor data accumulated since a previous transferring of the physical activity information is transferred.

In an embodiment of the invention, the remote on-line service application is deployed at a server device remotely located from the networked computing device. In this embodiment, the user's configuration of the remote on-line service application deployed at the server device remotely located from the networked computing device is modified based on the transferred physical activity information.

In an embodiment of the invention, the remote on-line service application comprises a server portion deployed at a server device remotely located from the networked computing device and a client portion deployed at the networked computing device. In this embodiment, the user's configuration of the remote on-line service application is modified via the client portion deployed at the networked computing device.

In an embodiment of the invention, the physical activity information is transferred from the mobile device to the networked computing device via a short-range wireless connection.

In an embodiment of the invention, the physical activity sensor comprises a physical activity sensor external to the mobile device.

In an embodiment of the invention, the physical activity sensor comprises a physical activity sensor internal to the mobile device.

The embodiments of the invention described above may be used in any combination with each other. Several of the embodiments may be combined together to form a further embodiment of the invention. A method, a computer program, a mobile device, or a networked computing device which is an aspect of the invention may comprise at least one of the embodiments of the invention described above.

The invention allows modifying a user's configuration of a remote on-line service application in accordance with accumulated physical activity data of the user. As a result, the invention allows collecting, presenting and utilizing information about physical activity in a way that is well suited for casual, everyday use.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a flow diagram illustrating a method according to an embodiment of the present invention; and

FIG. 2 is a block diagram illustrating devices according to an embodiment of the present invention.

### DETAILED DESCRIPTION OF THE PREFERRED EMBODIMENTS

Reference will now be made in detail to the embodiments of the invention, examples of which are illustrated in the accompanying drawings.

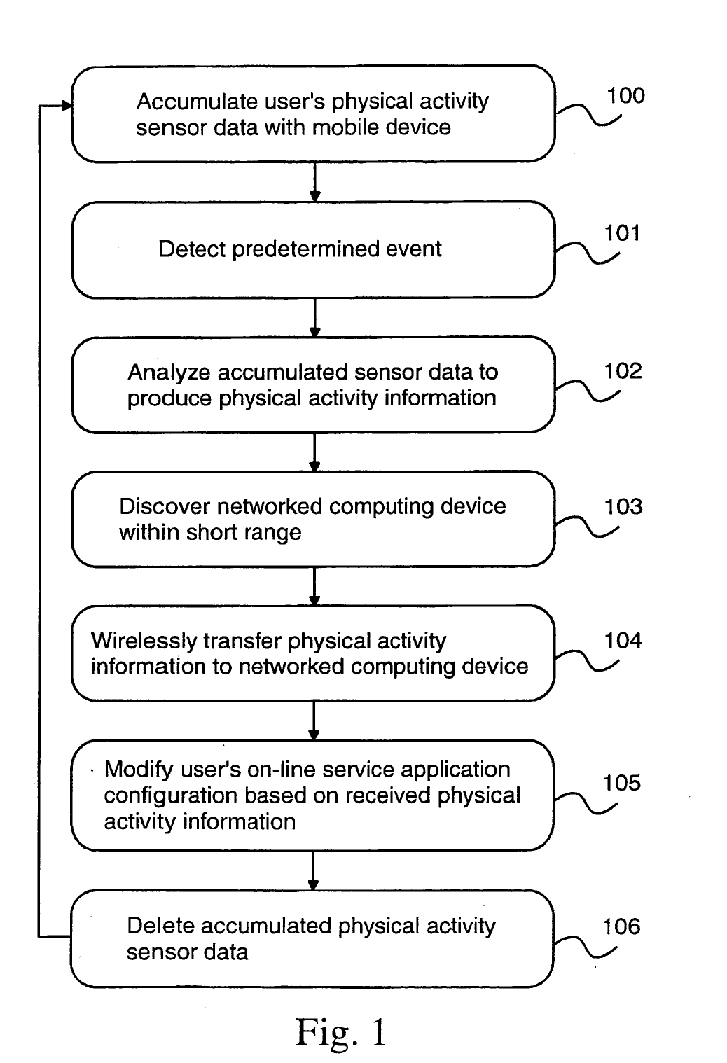

FIG. 1 is a flow diagram that illustrates a method related to modifying a user's configuration of a remote on-line service application in accordance with accumulated physical activity data of the user. The term “physical activity” is herein used to refer to the user's physical movement that can be detected and measured with sensors. The physical activity may be fitness or exercise activity, but the physical activity may also be everyday, casual movement, such as walking performed during a day.

At step 100, physical activity sensor data of a user is accumulated, over a period of time, in a mobile device from a physical activity sensor. At step 101, a predetermined event is detected. The predetermined event may comprise e.g. a predetermined command that is input by the user with e.g. a user interface of the mobile device. Typically, physical activity sensor data is accumulated over a lengthy period of time. For example, the user may input the predetermined transfer triggering command at evenings, thereby allowing accumulation of the physical activity sensor data over a whole day. In another embodiment, the predetermined event may comprise a lapsing of a predetermined accumulation period.

At optional step 102, the accumulated physical activity sensor data may be analyzed with the mobile device. In another embodiment, the analysis of the accumulated physical activity sensor data may be performed before detecting the predetermined event at step 101. In yet another embodiment, the analysis of the accumulated physical activity sensor data may be performed after transferring physical activity information at step 104 but before modifying user's on-line service application configuration at step 105. If the analysis of the accumulated physical activity sensor data is performed, the physical activity information to be utilized in the modification at step 105 may comprise results of this performed analysis. In still another embodiment, no analysis of the accumulated physical activity sensor data is performed. In such an embodiment, the physical activity information to be utilized in the modification at step 105 may comprise the accumulated physical activity sensor data in the raw.

At optional step 103, a networked computing device located within a short range of the mobile device may be discovered with the mobile device. In case this discovery is performed, the physical activity information may be transferred to the discovered networked computing device. In another embodiment, no discovery of networked computing devices is performed. Rather, the networked computing device to which the physical activity information is to be transferred may have been determined in advance, and identification information about this predetermined networked computing device or information concerning a communication channel to this predetermined networked computing device has been stored at the mobile device.

At step 104, physical activity information is transferred from the mobile device to a networked computing device, wherein the physical activity information is based on the accumulated physical activity sensor data. In the embodiment of the invention depicted in FIG. 1, the physical activity information is transferred wirelessly. However, those skilled in the art will appreciate that the physical activity information may alternatively be transferred via a wired link. Furthermore, the mobile device may send its identity information to the networked computing device along with the physical activity information thereby allowing the computing device identify the mobile device and the user sending the physical activity information. This may be useful for example in cases of a computing device being shared by family members each having their own mobile device of the invention. To enable this, the mobile device may have a unique identifier stored within.

At step 105, based on the transferred physical activity information, the user's configuration of a remote on-line service application is modified with the networked computing device. In an embodiment, the modification of the user's configuration of the remote on-line service application may comprise one of allowing or denying the user's access to at least a portion of the remote on-line service application in accordance with the transferred physical activity information. For example, the on-line service application may be a virtual sports club access to which is granted only if the user's physical activity during predetermined period exceeds a predetermined amount.

In another embodiment, the modification of the user's configuration of the remote on-line service application may comprise modifying a predetermined feature of the remote on-line service application in accordance with the transferred physical activity information. For example, the on-line service application may be an on-line community with the user represented by an avatar or the like, wherein visual or other features of the avatar may be modified in accordance with the user's physical activity.

In addition/alternatively, the user's configuration of the remote on-line service application may be modified based on predetermined inactivity data if a predetermined inactivity period lapses with no physical activity information received. For example, a previously granted access to an on-line service application may once again be denied if no physical activity information is received within the predetermined inactivity period.

At optional step 106, the accumulated physical activity sensor data based on which the modification of the user's configuration of the remote on-line service application at step 105 was performed may be deleted from the mobile device. Alternatively, the accumulated physical activity sensor data may e.g. have an associated validity period after which at least a portion of it is deleted from the mobile device.

Finally, the method returns to step 100 to allow more physical activity sensor data to be accumulated and subsequently to allow the user's configuration of the remote on-line service application to be re-modified.

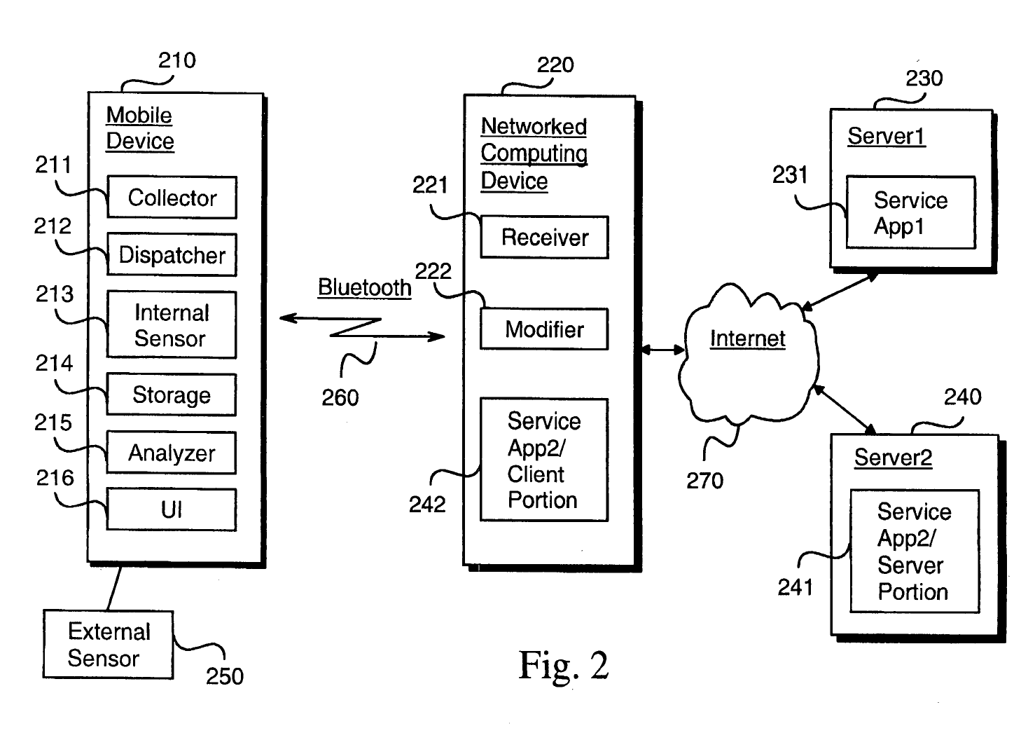

FIG. 2 is a block diagram illustrating devices according to an embodiment of the present invention. A mobile device 210 and a computing device 220 are configured to communicate with each other via a communication link. In the embodiment of the invention depicted in FIG. 2, the communication link is a short range wireless communication link 260, such as e.g. a short range wireless communication link based on Bluetooth technology, on Universal Plug and Play (UPnP) technology, on Near Field Communication (NFC) technology, or on Wireless Universal Serial Bus (WUSB) technology. The term “short range” is herein used in the context of wireless radio frequency communication and refers to distances below approximately 100 meters. However, those skilled in the art will appreciate that the wireless communication link 260 may be replaced with a wired link.

The computing device 220 is networked. That is, the computing device 220 is connected, via a wired or wireless connection, to a public computer network 270, such as e.g. Internet. The computing device 220 may be e.g. a networked personal computer, a networked smart phone, or a networked game console. Servers hosting service applications are also connected to the public computer network 270. In other words, the service applications are “on-line” service applications. As examples, FIG. 2 illustrates Servers 230 and 240 hosting service applications 231 and 241, respectively.

A service application may be deployed at a singular server. The first service application 231 illustrated in FIG. 2 is an example of such a case. However, as is appreciated by those skilled in the art, a service application may also be distributed. For example, a service application may comprise a client portion and a server portion. The second service application hosted by the server 240 is an example of such a case, wherein a server portion 241 is deployed at the server 240 and a client portion 242 is deployed at the computing device 220. However, regardless of whether the service applications are distributed or not, the actual service providing portions are deployed at devices other than the networked computing device 220 itself. Thus, the service applications are considered to be “remote”.

In an embodiment, the mobile device 210 comprises an internal physical activity sensor 213. In addition/alternatively, the mobile device 210 may comprise at least one external physical activity sensor 250 that is connected to the mobile device 210 via a wired or wireless link. The physical activity sensor(s) 213 and/or 250 may comprise e.g. a pedometer and/or a cyclometer. In an embodiment, the external physical activity sensor 250 may be arranged in connection with an external apparatus, such as an exercise cycle. In case at least one external physical activity sensor that is located within a short range of the mobile device 250 is to be connected via a wireless link with the mobile device 250, the mobile device 210 may be configured to discover such external physical activity sensors.

Furthermore, the mobile device 210 comprises a collector 211 that is configured to accumulate, over a period of time, physical activity sensor data of a user from the physical activity sensor(s) 213 and/or 250. The mobile device 210 may further comprise an analyzer 215 that is configured to analyze the physical activity sensor data accumulated with the physical activity sensor(s) 213 and/or 250. However, it is to be understood that while the embodiment of FIG. 2 depicts the analyzer 215 deployed at the mobile device 210, in another embodiment the analyzer 215 may be deployed at the networked computing device 220. The mobile device 210 may further comprise a storage 214 that is configured to store the accumulated physical activity sensor data and/or results of the analysis performed by the analyzer 215.

The mobile device 210 may further comprise a user interface 216. The user interface 216 may comprise a keypad or the like configured to e.g. receive commands from the user. The user interface 216 may further comprise a display component or the like configured to e.g. display the accumulated physical activity sensor data and/or results of the analysis performed by the analyzer 215 to the user.

The mobile device 210 further comprises a dispatcher 212 that is configured to dispatch the physical activity information to the networked computing device 220. As discussed above, the physical activity information to be dispatched is based on the accumulated physical activity sensor data. Furthermore, the mobile device 210 is configured to detect a predetermined event that triggers the dispatcher 212 to perform the above dispatching of the physical activity information. Such a predetermined event may be e.g. a given command input by the user with the user interface 216. In another embodiment, the predetermined event may comprise a lapsing of a predetermined accumulation period. To allow detecting the lapsing of the predetermined accumulation period, e.g. an internal clock (not shown) may be arranged in the mobile device 210. In addition, the internal clock may be utilized in attaching time stamps to the accumulated physical activity data. The dispatched physical activity information will be transferred to the networked computing device 220 over the communication link 260.

As discussed above, the mobile device 210 may be connected to the networked computing device 220 via the short range wireless communication link 260. In such a case, the mobile device 210 may be configured to discover the networked computing device 220.

The networked computing device 220 comprises a receiver 221 that is configured to receive the physical activity information dispatched by the dispatcher 212. The networked computing device 220 further comprises a modifier 222 that is configured to modify the user's configuration of the remote on-line service application(s) based on the received physical activity information. As discussed above, this modification may comprise e.g. allowing or denying the user's access to at least a portion of the remote on-line service application(s) in accordance with the transferred physical activity information. Alternatively, this modification may comprise e.g. modifying a given feature(s) of the remote on-line service application(s) in accordance with the transferred physical activity information.

When an on-line service application is completely deployed at a server device, e.g. the first service application 231 deployed at the server 230, the user's configuration of the remote on-line service application may be modified via communication between the modifier 222 and the first service application 231. Correspondingly, when an on-line service application comprises a client portion deployed at the computing device, e.g. the service application client portion 242 deployed at the computing device 220, the user's configuration of the on-line service application may be modified via communication between the modifier 222 and the service application client portion 242 which then may communicate with the respective service application server portion 241. Information identifying the user may also be sent to the first service application 231 or the client portion 242 of the second service application. In an embodiment, the communication from the modifier 222 to the first service application 231 or to the service application client portion 242 comprises the physical activity information for use by the respective service application.

In an embodiment, the first service application 231, or the client portion 242 or the server portion 241 of the second service application may be further configured to determine when a predetermined inactivity period lapses, and to modify the user's configuration of the respective remote on-line service application based on predetermined inactivity data if the inactivity period lapses with no communication from the modifier 222. The length of the inactivity period may depend e.g. on the respective service application or on the respective physical activity information.

The exemplary embodiments can include, for example, any suitable servers, workstations, PCs, lap-top computers, personal digital assistants (PDAs), Internet appliances, handheld devices, cellular telephones, smart phones, wireless devices, game consoles, other devices, and the like, capable of performing the processes of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, 3G communications networks, Public Switched Telephone Network (PSTNs), Packet Data Networks (PDNs), the Internet, intranets, a combination thereof, and the like.

It is to be understood that the exemplary embodiments are for exemplary purposes, as many variations of the specific hardware used to implement the exemplary embodiments are possible, as will be appreciated by those skilled in the hardware and/or software art(s). For example, the functionality of one or more of the components of the exemplary embodiments can be implemented via one or more hardware and/or software devices.

The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be conveniently implemented using one or more general purpose processors, microprocessors, digital signal processors, micro-controllers, and the like, programmed according to the teachings of the exemplary embodiments of the present inventions, as will be appreciated by those skilled in the computer and/or software art(s). Appropriate software can be readily prepared by programmers of ordinary skill based on the teachings of the exemplary embodiments, as will be appreciated by those skilled in the software art. In addition, the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware and/or software.

Stored on any one or on a combination of computer readable media, the exemplary embodiments of the present inventions can include software for controlling the components of the exemplary embodiments, for driving the components of the exemplary embodiments, for enabling the components of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the components of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDR, CD-RW, DVD, DVD-ROM, DVD±RW, DVD±R, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

What is claimed is:

1. A method comprising:
accumulating, over a period of time, physical activity sensor data of a user in a mobile device from a physical activity sensor;
transferring, in response to a predetermined event, physical activity information from the mobile device to a networked computing device, the physical activity information based on the accumulated physical activity sensor data; and
modifying, with the networked computing device, the user's configuration of a remote on-line service application based on the transferred physical activity information.

2. The method according to claim 1, further comprising:
analyzing, with the mobile device, the accumulated physical activity sensor data;
wherein the transferring of the physical activity information comprises transferring results of the analysis.

3. The method according to claim 1, wherein the transferring of the physical activity information comprises transferring the accumulated physical activity sensor data.

4. The method according to claim 1, wherein the modifying of the user's configuration of the remote on-line service application comprises one of allowing or denying the user's access to at least a portion of the remote on-line service application.

5. The method according to claim 1, wherein the modifying of the user's configuration of the remote on-line service application comprises modifying a predetermined feature of the remote on-line service application.

6. The method according to claim 1, wherein the transferring of the physical activity information in response to a predetermined event comprises transferring the physical activity information in response to a predetermined command input by the user.

7. The method according to claim 1, wherein the transferring of the physical activity information to the networked computing device comprises transferring the physical activity information to a predetermined networked computing device.

8. The method according to claim 1, further comprising:
discovering, with the mobile device, a networked computing device located within a short range of the mobile device;
wherein the transferring of the physical activity information to the networked computing device comprises transferring the physical activity information to the discovered networked computing device.

9. The method according to claim 1, further comprising:
periodically repeating the accumulating of the physical activity sensor data, the transferring of the physical activity information, and the modifying of the user's configuration of the remote on-line service application;
wherein each repeat of the transferring of the physical activity information comprises transferring physical activity information based on physical activity sensor data accumulated since a previous transferring of the physical activity information.

10. A computer program embodied on a computer readable medium, the computer program controlling a data-processing device to perform the steps of:
accumulating, over a period of time, physical activity sensor data of a user in a mobile device from a physical activity sensor;
transferring, in response to a predetermined event, physical activity information from the mobile device to a networked computing device, the physical activity information based on the accumulated physical activity sensor data; and
modifying, with the networked computing device, the user's configuration of a remote on-line service application based on the transferred physical activity information.

11. The computer program according to claim 10, wherein the remote on-line service application is deployed at a server device remotely located from the networked computing device, and wherein the modifying of the user's configuration of the remote on-line service application comprises modifying the user's configuration of the remote on-line service application deployed at the server device remotely located from the networked computing device.

12. The computer program according to claim 10, wherein the remote on-line service application comprises a server portion deployed at a server device remotely located from the networked computing device and a client portion deployed at the networked computing device, and wherein the modifying of the user's configuration of the remote on-line service application comprises modifying the user's configuration of the remote on-line service application via the client portion deployed at the networked computing device.

13. A mobile device, comprising:
a collector configured to accumulate, over a period of time, physical activity sensor data of a user from a physical activity sensor; and
a dispatcher configured to dispatch, in response to a predetermined event, physical activity information based on the accumulated physical activity sensor data to a networked computing device for use in modifying, with the networked computing device, the user's configuration of a remote on-line service application based on the dispatched physical activity information.

14. The mobile device according to claim 13, wherein the dispatcher is further configured to dispatch the physical activity information to the networked computing device via a short-range wireless connection.

15. The mobile device according to claim 13, wherein the physical activity sensor comprises a physical activity sensor external to the mobile device.

16. The mobile device according to claim 13, wherein the physical activity sensor comprises a physical activity sensor internal to the mobile device.

17. A networked computing device, comprising:
a receiver configured to receive, from a mobile device, physical activity information based on physical activity sensor data of a user accumulated in the mobile device over a period of time from a physical activity sensor; and
a modifier configured to modify the user's configuration of a remote on-line service application based on the received physical activity information.

18. The networked computing device according to claim 17, wherein the receiver is further configured to receive the physical activity information from the mobile device via a short-range wireless connection.

19. A mobile device, comprising:
a collecting means for accumulating, over a period of time, physical activity sensor data of a user from a physical activity sensor; and
a dispatching means for dispatching, in response to a predetermined event, physical activity information based on the accumulated physical activity sensor data to a networked computing device for use in modifying, with the networked computing device, the user's configuration of a remote on-line service application based on the dispatched physical activity information.

20. A networked computing device, comprising:
a receiving means for receiving, from a mobile device, physical activity information based on physical activity sensor data of a user accumulated in the mobile device over a period of time from a physical activity sensor; and
a modifying means for modifying the user's configuration of a remote on-line service application based on the received physical activity information.
